(19) United States
(12) Patent Application Publication
(10) Pub. No.: US 2017/0011671 A1
(43) Pub. Date: Jan. 12, 2017

(54) COLLAPSIBLE DISPLAY

(71) Applicant: Steven J. Goldrich, Portland, OR (US)

(72) Inventor: Steven J. Goldrich, Portland, OR (US)

(21) Appl. No.: 15/205,718

(22) Filed: Jul. 8, 2016

Related U.S. Application Data
(60) Provisional application No. 62/190,668, filed on Jul. 9, 2015.

(51) Int. Cl. G09F 15/00

(52) U.S. Cl. CPC G09F 15/0031; G09F 15/0062; G09F 15/0012; G09F 2015/0093

(57) ABSTRACT

A display wall system is provided that has a flexible frame member with inflatable members and a plurality of panel members that can be positioned within the flexible frame member to provide rigidity to the display wall system when the inflatable members are inflated.

### CROSS REFERENCE TO RELATED APPLICATION

This application claims the benefit of U.S. Provisional Application No. 62/190,668, filed Jul. 9, 2015, which is herein incorporated by reference in its entirety.

### FIELD

This disclosure relates to collapsible walls and wall members, and, more particularly, to collapsible, rigid inflatable displays.

### BACKGROUND

Various collapsible walls and display structures have been developed. However, these conventional structures have significant drawbacks.

### SUMMARY

In some embodiments, a display wall system is provided that has a flexible frame member with inflatable members and a plurality of panel members that can be positioned within the flexible frame member to provide rigidity to the display wall system when the inflatable members are inflated. The flexible frame member can have a plurality of inflatable members and a cover extending between the plurality of inflatable members. Each of the inflatable members have a deflated configuration and an inflated configuration. Panel-receiving areas are formed between the inflatable members and cover when in the deflated configuration.

The system can include a plurality of panel members that have at least two openings and a plurality of coupling devices that have at least one extending member sized to be received in respective openings of the panel members to secure at least two of the panel members together and form a plurality of coupled panels. The plurality of coupled panel members can be received in the panel-receiving areas to form a rigid support member when the inflatable members are in the inflated configuration.

The openings of the plurality of panel members can include elongated slots and the =coupling devices can include a backing panel with an elongated pin member. Panel members can be curved, straight, or any other desired shape. A graphic cover can be positioned on or over the flexible frame member.

In another embodiment, a method of assembling a display wall system is provided. The method includes coupling a plurality of panel members together to form a plurality of coupled structural members and positioning the coupled structural members into panel-receiving areas of a flexible frame member. The panel-receiving areas of the flexible frame can be located between a plurality of inflatable members and a cover coupled to the inflatable members. The inflatable members can be inflated to exert a pressure between the inflated inflatable members and cover to secure the coupled structural members to the flexible frame member.

The act of coupling the plurality of panel members together can include inserting a pin member of a backing panel into respective openings on the panel members to secure adjacent panel members together. The plurality of panel members can be curved to form a generally curved display wall system or generally straight to form a flat display wall. A graphic cover can be secured to the flexible frame member.

### BRIEF DESCRIPTION OF THE DRAWINGS

FIG. 1: Freestanding display wall.

FIG. 2: Illustrates the inner frame of the display wall without printed graphic cover.

FIG. 3: Shows variations in shape of the display wall.

FIG. 4: Wall portion with cross section.

FIG. 5: Exploded view of a wall portion illustrating basic components.

FIG. 6: Wall portion showing open fasteners.

FIG. 7: Alternate exploded view of wall section components.

FIG. 8: Shows detail of wall member with cross section and printed graphic cover.

FIG. 9: Shows detail of wall member with cross section and open fasteners.

FIG. 10: Exploded view of a curved panel assembly.

FIG. 11: Panel assembly portion.

FIG. 12: Assembled backing plate.

FIG. 13: Top view of a wall portion.

FIG. 14: Top view of a panel assembly portion.

FIG. 15: Stacked panels.

FIG. 16: Basic panel design.

### DETAILED DESCRIPTION

The following description is exemplary in nature and is not intended to limit the scope, applicability, or configuration of the invention in any way. Various changes to the described embodiment may be made in the function and arrangement of the elements described herein without departing from the scope of the invention.

As used in this application and in the claims, the singular forms “a,” “an,” and “the” include the plural forms unless the context clearly dictates otherwise. Additionally, the term “includes” means “comprises.” Further, the term “associated” generally mean electrically, electromagnetically, and/or physically (e.g., mechanically or chemically) coupled or linked and does not exclude the presence of intermediate elements between the coupled or associated items absent specific contrary language.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

Moreover, for the sake of simplicity, the attached figures may not show the various ways (readily discernable, based on this disclosure, by one of ordinary skill in the art) in which the disclosed system, method, and apparatus can be used in combination with other systems, methods, and apparatuses. Additionally, the description sometimes uses terms such as “produce” and “provide” to describe the disclosed method. These terms are high-level abstractions of the actual operations that can be performed. The actual operations that correspond to these terms can vary depending on the particular implementation and are, based on this disclosure, readily discernible by one of ordinary skill in the art.

The compact collapsible tension fabric display is a shaped inflatable display system. A freestanding display system used to display graphics in a retail, trade show or advertising environment. High-pressure air struts are used to form a rigid element to secure loose panels reinforcing them to create a rigid structure.

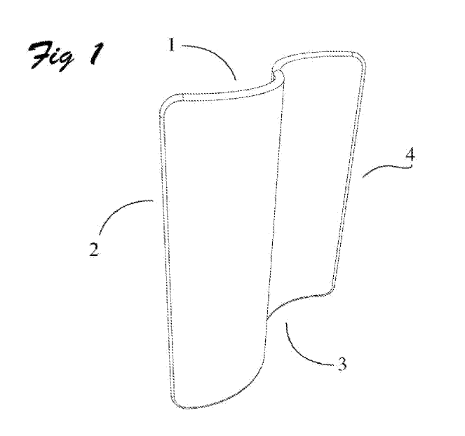

As shown in FIG. 1, in some cases the design can be a freestanding wall (1) of varying height that utilizes a full rapping printed graphic cover (2).

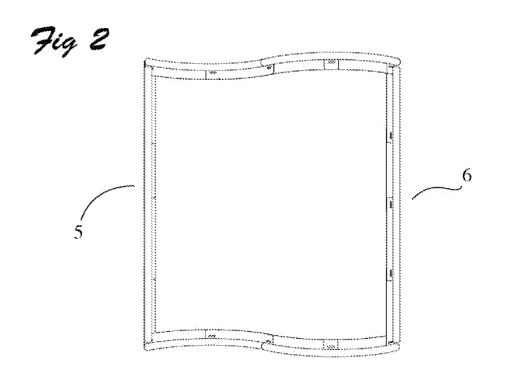

As shown in FIG. 2, consistent continuous tangential curves (3) and rigid straight vertical members (4) form an internal frame (5), creating a drum-like cohesive interconnected structure (6). The tension created by the structure provides a rigidity by locking each component together in its expanded shape.

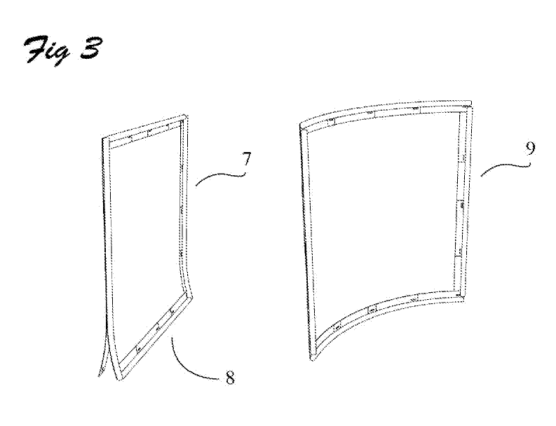

As shown in FIG. 3, additionally the design can exist in multiple configurations including straight walls (7) with enlarged base (8) as well as curved, conical and abstract wall shapes (9).

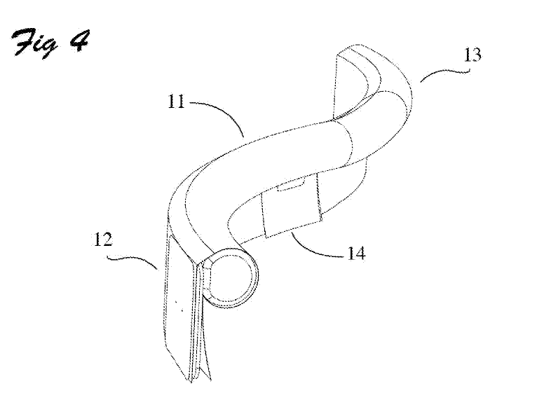

As shown in FIG. 4, wall sections (11) can include a backing plate (12) secured to a fabric cover enclosure with flexible lashings (14) to secure the internal components. The flexible lashings can be formed of any material suitable for securing the components together. Preferably, the lashings can be easily and quickly secured and removed to allow easy setup and takedown, such as by using Velcro lashings.

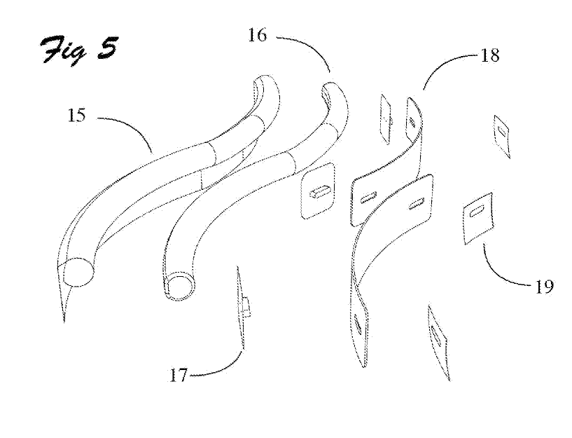

As shown in FIGS. 3 and 5, a flexible fabric frame is formed by the cover (15) and a plurality of inner pneumatic bladders (16) located at each side of the cover. Cover The backing plate (17) is shown as well as the panel structural members (18). At least some of the panel structural members can have the same shape (curved and/or straight), allowing for convenient packaging and assembly.

As shown in FIG. 6, panels (19) and lashings overlap at junctions to secure and form a rigid structure (20). Thus, once inflated, the bladders form an inflatable strut (21) that provides a stabilizing force against the panel structure members (18) and creates a tensioned smooth surface (22) for a graphic cover with a Smooth low-profile non-protruding back face (23). Graphic cover can be formed of any suitable flexible material that can receive graphics on the material, or that can be used to support another material that can display graphics or other visual information. In one embodiment, the graphic cover can comprise an aluminum composite material with a graphic contained thereon, such as pre-painted sheets of aluminum with a flexible polyethylene core.

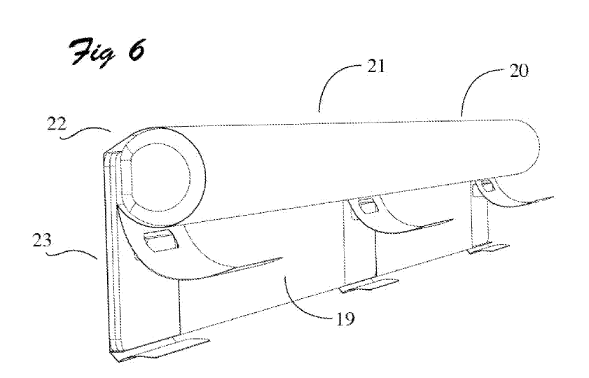

As shown in FIG. 7, as well as curved components, straight variable length components are also possible with varying connection locations (24).

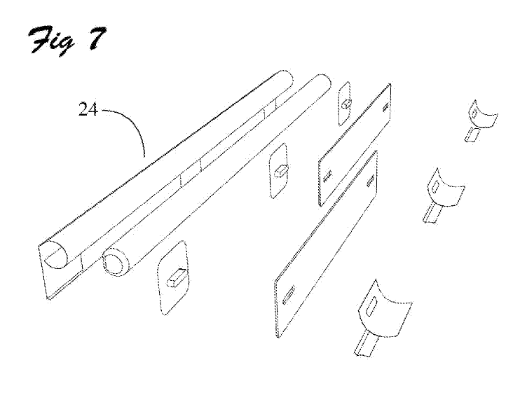

As shown in FIG. 8, the panels form a locked lap joint (25) secured from rotation by a linear tenon pin (26). A tensioned inflatable cover (27), forming a smooth front graphic display surface (28), provides reinforcement. The inflated volume creates a raised member (29) creating a reduced visual distraction, anomalies and surface irregularities. Graphic surface irregularity draws the eye and produces a sub-par graphic display surface.

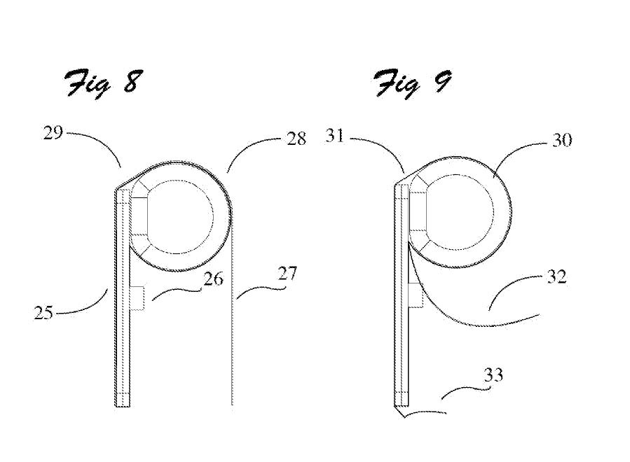

As shown in FIG. 9, the high-pressure pneumatic vessel (30) keeps the graphic elevated above the panels edges (31) while containment straps (32) and fasteners (33) are concealed under the protruding feature. These features render the components invisible through the graphic cover.

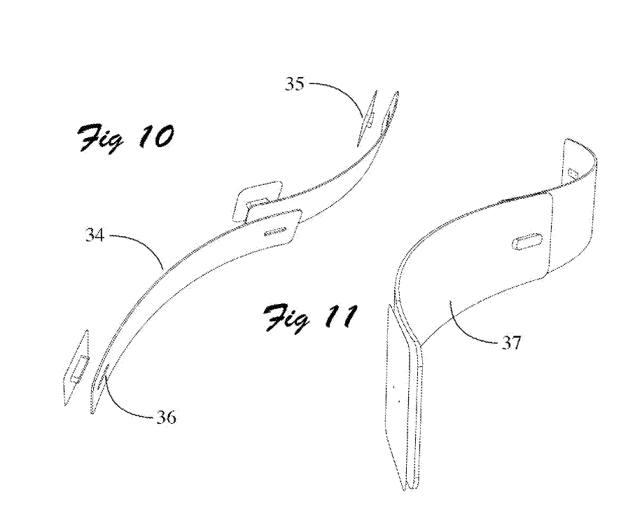

As shown in FIG. 10, a panel assembly without an inflated member (34) is held together by a basic backing plate with a linear type tenon pin (35) that corresponds to a linear slot (36) in a corresponding panel. Backing plates and pins can be formed from any suitable material. In one embodiment, the backing plate is formed a generally rigid and lightweight plastic material such as ABS, and the pin can be an aluminum pin riveted in place to the backing plate. In other embodiments, the backing plate and pin can be integrally formed of the same material.

As shown in FIG. 11, a complete inner panel frame structure is achieved by these two main components (37).

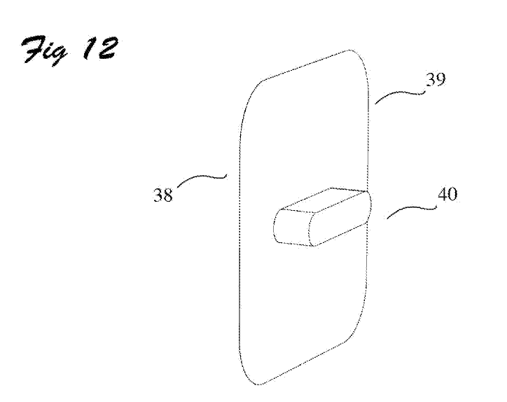

As shown in FIG. 12, a typical backing plate assembly (38) has a flat flange (39) to prevent the linear tenon pin (40) from slipping through the corresponding slot in the panel components.

As shown in FIG. 13, a typical Top View illustration, illustrates a smooth consistent graphic surface and low-profile cross-section (41), with the minimal amount of panel edge showing through the printed graphic cover in the rear (42).

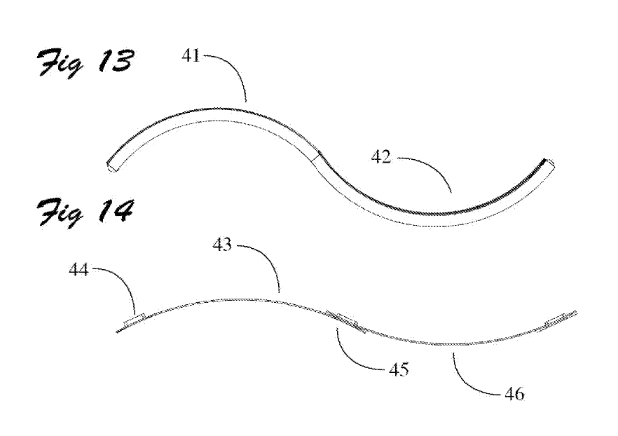

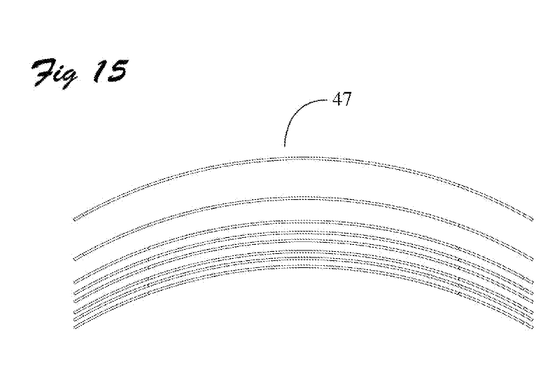

As shown in FIG. 14, a top view of a panel assembly with out an inflated member (43), illustrates an asymmetrical assembly (44), minimal cross-section (45) and smooth continuous tangent curve (46).

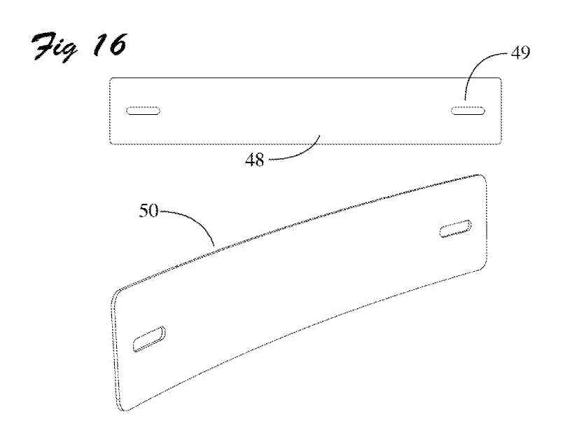

As shown in FIG. 15, intended to be stored in a compact manner components are designed to nest or stack together to form a compacted final form factor (47).

As shown in FIG. 16, panel components are symmetrical (48) and ambidextrous with universal and reversible features (49). A single panel illustration (50) shows the essential core concept of this lightweight, rigid, shaped, inflatable, and collapsible display system.

To assemble the display wall, a plurality of panels are coupled together by the backing plates with pins, such that adjacent panels overlap with one another. As best shown in FIGS. 8 and 9, the coupled panels are inserted into the flexible frame between the bladder and the cover on each side of the display wall. The bladders are then inflated to secure the panels into position between the bladders and the cover, with the locking panels substantially reducing vertical deflection under load. Thus, when all the bladders are inflated, and all the coupled panels secured to the flexible frame by the inflation pressure of the bladders, the panels and flexible frame create a stable structure onto which a graphic cover can be positioned. Graphic cover can be applied to the system in any known manner. In one embodiment, graphic cover can be a casing with an opening that can be secured over the structure. If desired, a closure can be provided at the opening of the graphic cover, such as a zipper or other closure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A display wall system, comprising:
a flexible frame member having a plurality of inflatable members and a cover extending between the plurality of inflatable members, each of the inflatable members have a deflated configuration and an inflated configuration, the inflatable members forming respective panel-receiving areas between the inflatable member and cover when in the deflated configuration;
a plurality of panel members having at least two openings; and
a plurality of coupling devices having at least one extending member sized to be received in respective openings of the panel members to secure at least two of the panel members together and form a plurality of coupled panels;
wherein the plurality of coupled panel members can be received in the panel-receiving areas to form a rigid support member when the inflatable members are in the inflated configuration.

2. The display wall system of claim 1, wherein the openings of the plurality of panel members comprise elongated slots.

3. The display wall system of claim 2, wherein the openings of the coupling devices comprise a backing panel with an elongated pin member.

4. The display wall system of claim 1, wherein at least some of the plurality of panel members are curved.

5. The display wall system of claim 1, wherein at least some of the plurality of panel members are flat.

6. The display wall system of claim 1, further comprising a graphic cover comprising an opening, the opening being sized to receive the flexible frame member within the graphic cover.

7. The display wall system of claim 1, wherein the panel members are at least three times as long as they are wide.

8. The display wall system of claim 1, further comprising a graphic cover comprising an opening, the opening being sized to receive the flexible frame member within the graphic cover.

9. The display wall system of claim 1, wherein the plurality of inflatable members are independently inflatable.

10. The display wall system of claim 1, wherein the plurality of inflatable members can be inflated together.

11. A method of assembling a display wall system comprising:
coupling a plurality of panel members together to form a plurality of coupled structural members;
positioning the coupled structural members into panel-receiving areas of a flexible frame member, the panel-receiving areas of the flexible frame being located between a plurality of inflatable members and a cover coupled to the inflatable members; and
inflating the inflatable members to exert a pressure between the inflated inflatable members and cover to secure the coupled structural members to the flexible frame member.

12. The method of claim 11, wherein the act of coupling the plurality of panel members together comprises inserting a pin member of a backing panel into respective openings on the panel members to secure adjacent panel members together.

13. The method of claim 11, wherein at least some of the plurality of panel members are curved to form a generally curved display wall system.

14. The method of claim 11, wherein at least some of the plurality of panel members are flat to form a generally flat display wall system.

15. The method of claim 11, further comprising securing a graphic cover to the flexible frame member.

16. The method of claim 15, wherein the graphic cover comprising an opening and the flexible frame member is inserted into the open of the graphic cover to cover the flexible frame member with the graphic cover.

17. The method of claim 11, wherein the inflatable members are independently inflatable.

18. The method of claim 11, wherein the inflatable members are in fluid connection with one another and can be inflated through one air-receiving area.
